(19) United States
(12) Patent Application Publication
(10) Pub. No.: US 2022/0223093 A1
(43) Pub. Date: Jul. 14, 2022

(54) DRIVING METHOD AND DRIVING SYSTEM OF DISPLAY PANEL

(71) Applicant: Everdisplay Optronics (Shanghai) Co.,Ltd., Shanghai (CN)

(72) Inventors: Linfan TIAN, Shanghai (CN); Xiangyu JIANG, Shanghai (CN); JehYen KANG, Shanghai (CN); Keitaro YAMASHITA, Shanghai (CN)

(73) Assignee: Everdisplay Optronics (Shanghai) Co.,Ltd., Shanghai (CN)

(21) Appl. No.: 17/571,605

(22) Filed: Jan. 10, 2022

(30) Foreign Application Priority Data
Jan. 11, 2021 (CN) 202110033009.2

(51) Int. Cl. G09G 3/20; G09G 3/3208

(52) U.S. Cl. CPC G09G 3/2007; G09G 3/3208; G09G 2320/0233; G09G 2310/061; G09G 2300/0842; G09G 2320/0247

(57) ABSTRACT

The present disclosure relates to the technical field of display panels and provides a driving method and a driving system of a display panel. The driving method of a display panel includes detecting a refresh rate of each frame of the display panel; in response to that the refresh rate of a current frame of the display panel changes relative to the refresh rate of a previous frame of the current frame, generating an adjustment instruction of an initialization voltage; determining a target initialization voltage of the current frame based on the adjustment instruction of the initialization voltage; and at a reset phase of the current frame, initializing a pixel drive circuit of the display panel with the target initialization voltage, so that a difference value between a working current of the pixel drive circuit in the current frame and a working current of the pixel drive circuit in the previous frame is less than a preset threshold.

### CROSS REFERENCE

This application is based upon and claims priority to Chinese Patent Application No. 202110033009.2, field on Jan. 11, 2021, the entire contents of which are incorporated herein by reference.

### TECHNICAL FIELD

The present disclosure relates to the technical field of display panels, in particular to a driving method and a driving system of a display panel.

### BACKGROUND

In order to adapt to different application scenarios of a display panel, the existing display panel usually has a function of changing a refresh rate in different application scenarios. For example, the display panel can be configured with Seamless Dynamic Refresh Rate Switching (SDRRS) technology. When in normal use, the display panel adopts a higher refresh rate, such as 60 Hz; but after entering a standby state, SDRRS technology switches the refresh rate of the display panel to a lower refresh rate, such as 40 Hz, thereby effectively reducing power consumption and saving energy.

How to reduce the difference in brightness of the display panel when the refresh rate is switched, and to avoid screen or picture flicker, has become a major technical problem for the display panel.

It should be noted that the information disclosed in the background art section above is only used to enhance the understanding of the background of the present disclosure, and therefore may include information that does not constitute the prior art known to those of ordinary skill in the art.

### SUMMARY

According to one aspect of the present disclosure, a driving method of a display panel is provided. The driving method may include detecting a refresh rate of each frame of the display panel; in response to that the refresh rate of a current frame of the display panel changes relative to the refresh rate of a previous frame of the current frame, generating an adjustment instruction of an initialization voltage; determining a target initialization voltage of the current frame based on the adjustment instruction of the initialization voltage; and at a reset phase of the current frame, initializing a pixel drive circuit of the display panel with the target initialization voltage, so that a difference value between a working current of the pixel drive circuit in the current frame and a working current of the pixel drive circuit in the previous frame is less than a preset threshold.

According to a second aspect of the embodiments of the present disclosure, there is provided a driving system of a display panel. The driving system is used to implement the driving method according to any one of embodiments mentioned above and may include: a refresh rate detection unit configured to detect a refresh rate of each frame of the display panel; an adjustment instruction generation unit configured to generate an adjustment instruction of an initialization voltage, in response to that the refresh rate of a current frame of the display panel changes relative to the refresh rate of a previous frame of the current frame; an initialization voltage determination unit configured to determine a target initialization voltage of the current frame based on the adjustment instruction of the initialization voltage; and an initialization voltage output unit configured to, at a reset phase of the current frame, initialize a pixel drive circuit of the display panel with the target initialization voltage, so that a difference value between a working current of the pixel drive circuit in the current frame and a working current of the pixel drive circuit in the previous frame is less than a preset threshold.

It should be understood that the above general description and the following detailed description are only exemplary and explanatory, and cannot limit the present disclosure.

### BRIEF DESCRIPTION OF THE DRAWINGS

The drawings here are incorporated into the specification and constitute a part of the specification, show embodiments in accordance with the present disclosure and are used to explain the principle of the present disclosure together with the specification. Obviously, the drawings in the following description are only some embodiments of the present disclosure. For those of ordinary skill in the art, other drawings can be obtained based on these drawings without creative work.

FIG. 1 shows a schematic diagram of voltage waveform regarding brightness of a display panel when switching between different refresh rates in the prior art.

FIG. 2 shows a schematic diagram of steps of a driving method of a display panel according to some embodiments of the present disclosure.

FIG. 3 is a schematic diagram showing a comparison between a brightness change of a display panel according to an embodiment of the present disclosure and a brightness change of a display panel in the prior art when the refresh rate is switched.

FIG. 4 shows a schematic structural diagram of a pixel drive circuit of each pixel according to some embodiments of the present disclosure.

FIG. 5 shows a schematic diagram of a current-voltage characteristic curve of a light-emitting element of a pixel drive circuit according to some embodiments of the present disclosure.

FIG. 6 shows a schematic diagram of modules of a driving system of a display panel according to some embodiments of the present disclosure.

FIG. 7 shows a schematic diagram of modules of a driving system of a display panel according to some embodiments of the present disclosure.

### DETAILED DESCRIPTION

Embodiments will now be described more fully with reference to the accompanying drawings. However, the embodiments can be implemented in various forms, and should not be construed as being limited to the embodiments set forth herein. On the contrary, these embodiments are provided so that the present disclosure will be comprehensive and complete, and will fully convey the concept of embodiments to those skilled in the art. The same reference numerals in the figures indicate the same or similar structures, and thus their repeated description will be omitted.

In addition, the drawings are only schematic illustrations of the present disclosure, and are not necessarily drawn to scale. The same reference numerals in the figures denote the same or similar parts, and thus their repeated description will be omitted. Some of block diagrams shown in the drawings are functional entities and do not necessarily correspond to physically or logically independent entities. These functional entities may be implemented in the form of software, or implemented in one or more hardware modules or integrated circuits, or implemented in different networks and/or processor devices and/or microcontroller devices.

The sequence numbers of the steps in the following embodiments are used to indicate different execution contents, and do not strictly limit the execution order between the steps. The ‘first’, ‘second’ and similar words used in the specific description do not indicate any order, quantity or importance, but are only used to distinguish different components. It should be noted that the embodiments of the present disclosure and the features in different embodiments can be combined with each other if there is no conflict.

In order to adapt to different application scenarios of a display panel, the existing display panel usually has a function of changing a refresh rate in different application scenarios. For example, the display panel can be configured with Seamless Dynamic Refresh Rate Switching (SDRRS) technology. When in normal use, the display panel adopts a higher refresh rate, such as 60 Hz; but after entering a standby state, SDRRS technology switches the refresh rate of the display panel to a lower refresh rate, such as 40 Hz, thereby effectively reducing power consumption and saving energy.

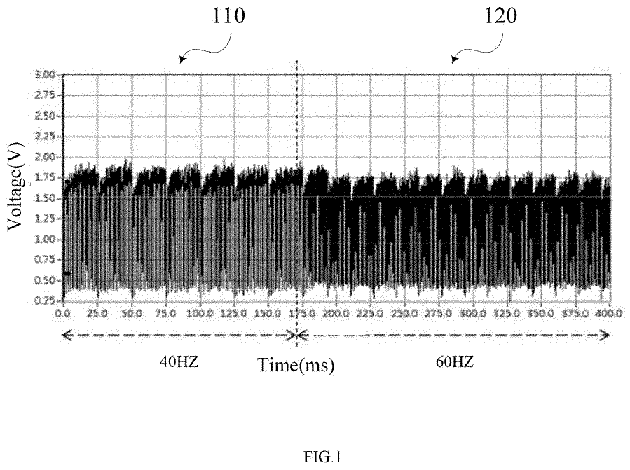

However, referring to a voltage waveform of brightness of the display panel when switching between different refresh rates (such as switching between 60 Hz and 40 Hz) in the prior art in shown in FIG. 1, the abscissa represents time, the ordinate represents voltage value corresponding to brightness, and the left half area 110 shows change of the voltage waveform corresponding to the brightness over time when the refresh rate is 40 Hz, and the right half area 120 shows change of the voltage waveform corresponding to the brightness over time when the refresh rate is 60 Hz. It can be seen that when the refresh rate of the display panel is switched, the picture brightness of the display panel has a large difference, which causes the displayed picture to flicker and affect the user experience.

In view of this, the present disclosure provides a driving method and a driving system for a display panel, which can, by adjusting an initial voltage, reduce the brightness difference of the display panel during switching of a refresh rate, eliminate visual picture flicker, and improve the use experience.

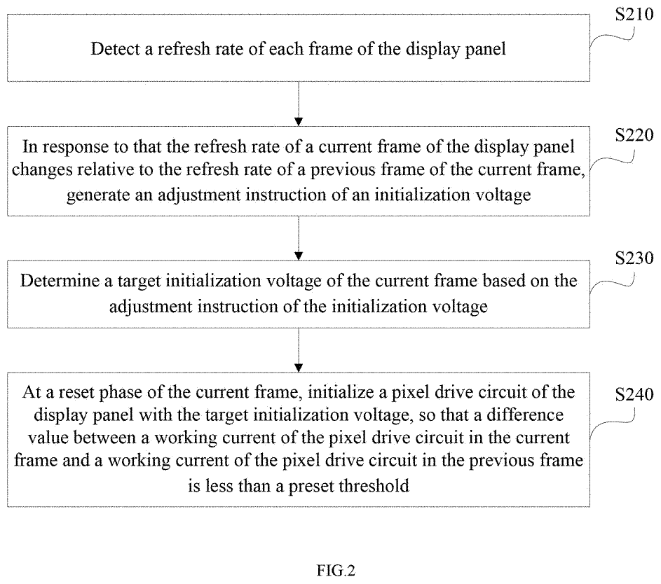

FIG. 2 shows main steps of the driving method of the display panel according to some embodiments. Referring to FIG. 2, the driving method of the display panel in the present disclosure may include the following steps.

In step S210, a refresh rate of each frame of the display panel is detected.

In step S220, in response to that the refresh rate of a current frame of the display panel changes relative to the refresh rate of a previous frame of the current frame, an adjustment instruction of an initialization voltage is generated.

In step S230, a target initialization voltage of the current frame is determined based on the adjustment instruction of the initialization voltage.

In step S240, at a reset phase of the current frame, a pixel drive circuit of the display panel is initialized by using the target initialization voltage, so that a difference value between a working current of the pixel drive circuit for the current frame and a working current of the pixel drive circuit for the previous frame is less than a preset threshold.

In the above driving method, the refresh rate of each frame of the display panel is detected, when the refresh rate of the current frame of the display panel is changed compared with that of the previous frame, a voltage adjustment instruction is sent, so that in a reset stage of the current frame of the display panel, the pixel drive circuit is initialized with the target initialization voltage adjusted based on the voltage adjustment instruction. Since initialization voltage of the pixel drive circuit directly affects the working current of the pixel drive circuit, the working current of the pixel drive circuit for the current frame can be changed after adjusting the initialization voltage of current frame, so that a difference value between the working current of current frame and the working current of the previous frame is within a preset threshold, and the preset threshold is an amount of current change corresponding to a brightness difference that is not easily noticeable to human eyes under a specific gray scale determined by experiments.

In the following, the steps of the driving method of the present disclosure will be described in detail with reference to specific examples. However, the present disclosure is not limited to the following applications. Any display panel that has a function of switching the refresh rate under different application scenarios can use the driving method of the present disclosure to reduce the brightness difference of the display panel when the refresh rate is switched.

In this example, the display panel, specifically an Organic Light-Emitting Diode (OLED) display panel, is configured on a computer, and the display panel uses SDRRS technology to achieve the refresh rate switch in different application scenarios. In case that the display panel turns on a SDRRS mode, when in normal use, the refresh rate of the display panel is 60 Hz; when the user does not perform any operation on the computer for a period of time, the refresh rate is switched to 40 Hz; if the user perform a certain operation on the computer again by a mouse or keyboard, the refresh rate of the display panel will be switched from 40 Hz back to 60 Hz. The switching of the refresh rate of the display panel is specifically implemented by controlling the change of a pixel clock frequency of a graphics chip, i.e., Graphics Processing Unit (GPU) of the display panel.

In step S110, the refresh rate of each frame of the display panel can be detected by a timing controller (TCON) of the display panel.

In step S120, when the refresh rate of the current frame of the display panel is changed compared to that of the previous frame, the timing controller TCON sends an adjustment instruction of the initialization voltage (Vint voltage), in order to change the working current of the display panel when the refresh rate is switched, thus reducing the brightness difference caused by switching the refresh rate. At this time, the GPU will change its pixel clock frequency, so as to switch the refresh rate of the display panel when the current frame arrives.

The process of generating the adjustment instruction of the initialization voltage by TCON specifically includes, when the refresh rate of the current frame is decreased relative to the refresh rate of the previous frame, an initialization voltage increase instruction is sent. In a display panel equipped with SDRRS technology, the reduction of the refresh rate of the current frame relative to the refresh rate of the previous frame (such as switching from 60 Hz to 40 Hz) corresponds to the display panel switching from a dynamic picture displayed in the previous frame to a static picture to be displayed in the current frame.

In the specific display gray scale of picture, the brightness of the display panel at a high refresh rate is lower than the brightness at a low refresh rate, resulting in a brightness difference when switching between different refresh rates. In this example, the initialization voltage increase instruction is sent when the display panel is switched to the low refresh rate, so that the working current of the display panel decreases with the increase of the initialization voltage, thus decreasing the display brightness of the display panel at the low refresh rate and further reducing the brightness difference when switching from the dynamic picture to the static picture, i.e., when switching from 60 Hz to 40 Hz.

In the case of detecting that the refresh rate of the current frame is increased compared with the refresh rate of the previous frame, the timing controller TCON can send an initialization voltage reduction instruction, so as to return the initialization voltage of the current frame to an initial setting value, thus realizing that initialization voltage provided to the pixel drive circuit decreases as the refresh rate of the display panel increases.

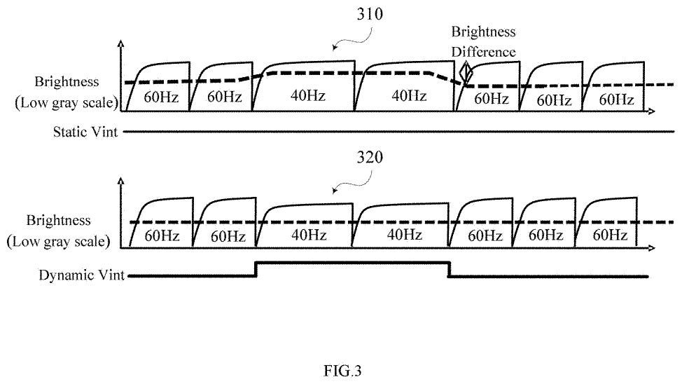

FIG. 3 shows a comparison of the brightness changes between the display panel according to the present disclosure and the display panel in the prior art when the refresh rate is switched, wherein the dotted line indicates the brightness change trend. Since human eyes are more sensitive to changes in brightness at low display gray scales, FIG. 3 shows the effect of the initialization voltage (Vint voltage) on the display brightness when the refresh rate is switched under the low display gray scales (such as lower than 128 gray scales). In FIG. 3, for driving method of the display panel in the prior art, referring to arrow 310, when the refresh rate of the display panel is switched between 60 Hz and 40 Hz, the Vint voltage provided to the pixel drive circuit is fixed (i.e., static Vint or unchanged Vint), and the display panel will produce a large difference in brightness, causing the screen to flicker. For the driving method of the display panel according to the present disclosure, referring to arrow 320, when the refresh rate is switched from 60 Hz to 40 Hz, the Vint voltage is increased, and the working current of the display panel decreases with the increasing of Vint voltage, and the display brightness at 40 Hz is reduced. Furthermore, when the refresh rate is switched from 40 Hz back to 60 Hz, the Vint voltage is reduced to make the Vint voltage return to the initial setting value. Therefore, the Vint voltage is dynamically adjusted, that is, dynamic Vint or changed Vint, thus realizing when switching between the different refresh rates, for example, when the display panel equipped with SDRRS technology switches between the dynamic picture and the static picture, the brightness difference caused by the change of the refresh rate is reduced, and the problem of screen flicker is reduced or even eliminated.

In step S130, the adjustment instruction of the initialization voltage may be received through a power supply chip (i.e., Power IC) of the display panel to determine the target initialization voltage. The process of Power IC determining the target initialization voltage of the current frame may include: according to the adjustment instruction of the initialization voltage, analyzing and obtaining a display gray scale and a refresh rate of the current frame; based on the display gray scale and the refresh rate of the current frame, obtaining the target initialization voltage corresponding to the display gray scale and the refresh rate of the current frame from a preset mapping relationship between the display gray scale, the refresh rate and the target initialization voltage.

The table 1 below shows the preset mapping relationship between the display gray scale, the refresh rate and the target initialization voltage. Furthermore, the dynamic Vint means that adjusting the voltage value when SDRRS switching to 40 Hz.

TABLE 1

| Gray scale | 255-64 | 64-32 | 32-16 |
|---|---|---|---|
| 60 Hz | −3 V | −3 V | −3 V |
| 40 Hz | −2.8 V | −2.7 V | −2.6 V |

In this example, according to the experimental results, a one-to-one mapping relationship between the display gray scale, the refresh rate and the target initialization voltage is preset in advance. When the Power IC receives the adjustment instruction of the initialization voltage, a corresponding target initialization voltage is obtained by accessing the mapping relationship. In other examples, specific calculation logic can also be pre-stored in the Power IC. When the Power IC receives the adjustment instruction of the initialization voltage, the target initialization voltage can be calculated through the preset calculation logic.

When the Power IC has not received the adjustment instruction of the initialization voltage, it can directly use the initialization voltage of the previous frame without accessing the mapping relationship.

In step S140, in the reset phase of the current frame, the Power IC transmits the target initialization voltage to the pixel drive circuit, initializes the pixel drive circuit, and changes the working current of the pixel drive circuit to adjust the brightness of the display panel, so as to achieve brightness compensation via the adjustment of the Vint voltage when the refresh rate is switched.

Further, the driving method further includes: charging the pixel drive circuit during a charging phase of the current frame; and driving a light-emitting element of the pixel drive circuit to emit light during a display phase of the current frame. The working current when the light-emitting element emits light would be changed due to the adjustment to the initialization voltage, thus the brightness is adjusted.

The table 2 below shows when the display panel is switched from 60 Hz to 40 Hz, the brightness value and its change amplitude of the display panel driven by the static Vint in the prior art as well as the brightness value and its change amplitude of the display panel of the present disclosure (driven by dynamic Vint according to the present disclosure), under different display gray scales.

TABLE 2

| | Brightness(nits) | | | | |
|---|---|---|---|---|---|
| Display | | 40 Hz | 40 Hz | Brightness | |
| gray | | (driven by | (driven by | change amplitude | |
| scale | 60 Hz | static Vint) | dynamic Vint) | static Vint | dynamic Vint |
| 16 | 0.87 | 1.00 | 0.91 | 15.35% | 4.87% |
| 32 | 5.25 | 5.72 | 5.36 | 8.96% | 2.02% |
| 64 | 24.21 | 24.99 | 24.35 | 3.22% | 0.56% |
| 96 | 59.60 | 60.93 | 59.86 | 2.23% | 0.44% |
| 128 | 111.98 | 113.97 | 112.33 | 1.78% | 0.31% |

Based on the measuring result of the brightness change amplitude when the refresh rate of the display panel is switched from 60 Hz to 40 Hz under the low gray scales (i.e., less than 128 gray scale) shown in the table 2, it can be seen that after using the driving method of the present disclosure, the brightness change amplitude when the refresh rate is switched is lower than that in the prior art. Because the human eye is more sensitive to the brightness at low gray scales, the more effective improvement of the brightness difference at low gray scales according to the present disclosure is very important and more helpful to overcome the picture flicker.

Compared with the prior art, the beneficial effects of the present disclosure include at least followings.

By detecting the refresh rate of each frame of the display panel, sending a voltage adjustment instruction in response to that the refresh rate of a current frame of the display panel is changed compared with that of a previous frame of the current frame, so that in a reset stage of the current frame, the pixel drive circuit of the display panel is initialized with the target initialization voltage adjusted based on the voltage adjustment instructions. Since initialized voltage of the pixel drive circuit directly affects the working current of the pixel drive circuit, the working current of the pixel drive circuit in the current frame can be changed after adjusting the initialization voltage of current frame, so that a difference value between the working current of current frame and the working current of the previous frame is within a preset threshold, and the preset threshold is an amount of current change corresponding to a brightness difference that is not easily noticeable to human eyes under a specific gray scale determined by experiments.

Therefore, in the technical solution of the present disclosure, by adjusting the initialization voltage, the brightness difference of the display panel when the refresh rate is switched can be reduced, the visual flicker of the screen or picture is eliminated, and the user experience is improved.

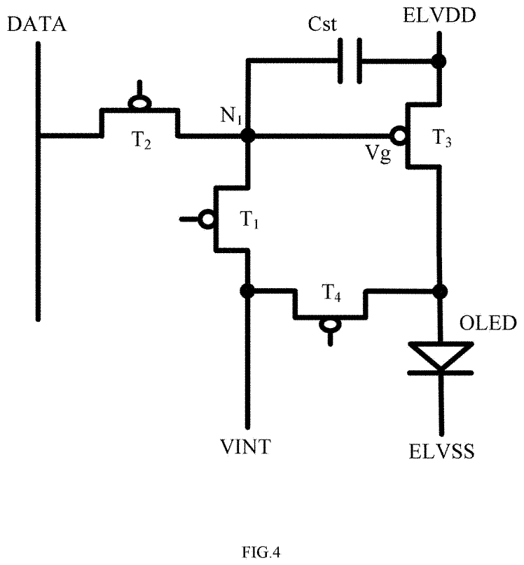

FIG. 4 shows the main structure of the pixel drive circuit of each pixel according to some embodiments. Referring to FIG. 4, the pixel drive circuit of each pixel may include a first transistor T₁, a storage capacitor Cst, a second transistor T₂, and a third transistor T₃.

The first transistor T₁ is coupled between an initialization voltage terminal VINT and a first node N₁ and at the reset phase, by using the target initialization voltage transmitted from the initialization voltage terminal VINT, the first node N₁ is initialized through the first transistor T₁. The storage capacitor Cst is coupled between the first node N₁ and an anode ELVDD of the power supply terminal. The second transistor T₂ is coupled between a data line DATA and the first node N₁, and at the charging phase, by using a data voltage transmitted from the data line DATA, the first node N₁ and the storage capacitor Cst are charged through the second transistor T₂. The third transistor T₃ is coupled between an anode of the light-emitting element OLED and the anode power supply terminal ELVDD, and a control terminal of the third transistor T₃ is coupled to the first node N₁. At the display phase, by using voltage stored in the storage capacitor Cst, the light-emitting element OLED is driven to emit light through the third transistor T₃. The ELVSS is a cathode power supply terminal.

The pixel drive circuit may further include a fourth transistor T₄ coupled between the initialization voltage terminal VINT and the anode of the light-emitting element OLED. At a second reset stage, the target initialization voltage also initializes the anode of the light-emitting element OLED through the fourth transistor T₄. The second reset phase is located between the charging phase and the display phase.

The control terminals of the first transistor T₁, the second transistor T₂, and the fourth transistor T₄ can respectively make a corresponding response to different timing signals, so that the pixel drive circuit sequentially enters the reset phase, the charge phase, and the second reset phase in each frame period, and finally the third transistor T₃, under the control of the first node N₁, causes the pixel drive circuit to enter the display phase and drive the light-emitting element OLED to emit light.

In the reset phase, the first transistor T₁ is turned on, and electric potential of the first node N₁, that is, gate potential Vg of the third transistor T₃, is initialized by the target initialization voltage, so that the gate potential Vg of the third transistor T₃ is stabilized at the target initialization voltage. Since the target initialization voltage is adjusted to increase, the gate potential Vg of the third transistor T₃ increases accordingly.

During the charging phase, the first transistor T₁ is turned off, the second transistor T₂ is turned on, and the gate of the third transistor T₃ and the storage capacitor Cst is charged by the data voltage. That is, before the light-emitting element OLED is lighted up, the storage capacitor Cst and the gate potential Vg of the third transistor T₃ would be initialized by the target initialization voltage and charged by the data voltage. When the charging time of the data voltage remains unchanged, the size of the target initialization voltage will directly affect the gate potential Vg of third transistor T₃ at the end of charging.

In the second reset stage, the first transistor T₁ and the second transistor T₂ are turned off, the fourth transistor T₄ is turned on, and the anode of the light-emitting element OLED is initialized by the target initialization voltage, so that the anode potential of the light-emitting element OLED is stabilized at the target initialization voltage.

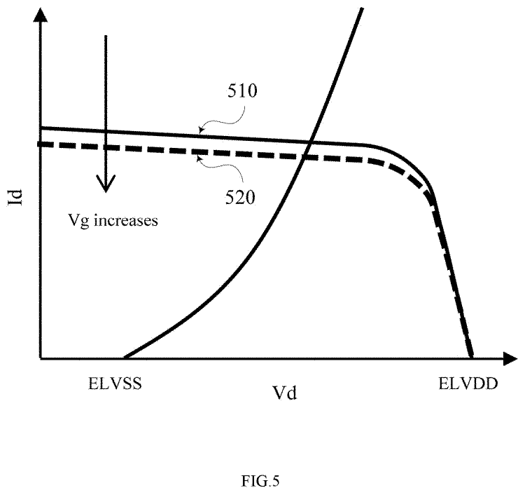

In the display phase, the first transistor T₁, the second transistor T₂, and the fourth transistor T₄ are turned off, and the third transistor T₃ is turned on, so as to drive the light-emitting element OLED to emit light. FIG. 5 shows the current-voltage characteristic curve of the light-emitting element of the pixel drive circuit according to some embodiments. Refer to FIG. 5, wherein Id is the working current of the light-emitting element OLED, Vd is the working voltage of the light-emitting element OLED, and curve 510 is the Id curve under a condition that the initialization voltage is unchanged, the curve 520 is the Id curve when the target initialization voltage is adopted, that is, in a case that the initialization voltage is changed, and the arrow indicates that Id decreases when Vg increases. According to the Id-Vd characteristic curve of the light-emitting element OLED, it can be seen that because the target initialization voltage increases, the gate potential Vg of the third transistor T₃ increases during initialization, which causes the working current Id of the light-emitting element OLED to decrease, and thus the brightness decreases.

When the light-emitting element OLED is lighted up, both the first transistor T₁ and the fourth transistor T₄ may leak electricity. When the first transistor T₁ leaks, the voltage difference ΔVg between its two terminals is ΔVg=Vg−Vint′, and Vint′ is the target initialization voltage. Since the target initialization voltage Vint′ increases, the voltage difference ΔVg across the first transistor T₁ decreases, so the leakage current becomes smaller, the leakage speed becomes slower, and the display performance is enhanced. When the fourth transistor T₄ leaks, the voltage cross the light-emitting element OLED will decrease, but the decrease of the cross voltage of the light-emitting element OLED has little effect on its current, so it can be ignored.

Using the driving method of any of the above-mentioned embodiments of the present disclosure, the adjustment of the initialization voltage can reduce the brightness difference of the display panel when the refresh rate is switched, thus solving the problem regarding brightness difference of the display panel when switching the refresh rate, eliminating the visual flicker of the screen or picture, and enhancing the user experience, especially under low display gray scales.

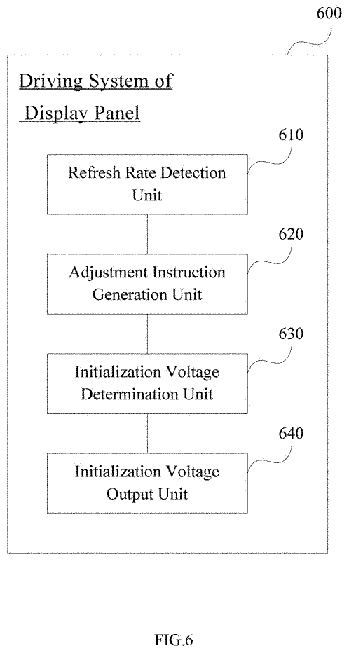

An embodiment of the present disclosure also provides a driving system of a display panel, which can be used to implement the driving method described in any of the foregoing embodiments. FIG. 6 shows the main modules of the driving system according to some embodiments. As shown in FIG. 6, the driving apparatus 600 in this embodiment includes a refresh rate detection unit 610, an adjustment instruction generation unit 620, an initialization voltage determination unit 630, and an initialization voltage output unit 640.

The refresh rate detection unit 610 is configured to detect a refresh rate of each frame of the display panel; and an adjustment instruction. The adjustment instruction generation unit 620 is configured to receive the refresh rate and generate an adjustment instruction of an initialization voltage, in response to that the refresh rate of a current frame of the display panel changes relative to the refresh rate of a previous frame of the current frame. The initialization voltage determination unit 630 is configured to receive the adjustment instruction and determine a target initialization voltage of the current frame based on the adjustment instruction of the initialization voltage. The initialization voltage output unit is configured to receive the target initialization voltage and at a reset phase of the current frame, initialize a pixel drive circuit of the display panel with the target initialization voltage, so that a difference value between a working current of the pixel drive circuit in the current frame and a working current of the pixel drive circuit in the previous frame is less than a preset threshold.

The refresh rate detection unit 610, the adjustment instruction generation unit 620, the initialization voltage determination unit 630, and the initialization voltage output unit 640 in the present disclosure can be implemented by the circuit or the integrated circuit, or implemented by the microprocessor, or implemented in other ways that are known in the art.

After the refresh rate detection unit 610 (i.e., the integrated circuit) receives a complete frame of the picture signal, it obtains the picture refresh rate by analyzing the data information stream. Specifically, after the picture signal comes into the integrated circuit, it obtains the gray scale and the refresh rate of the picture signal frame, looks up the corresponding mapping table, calculates the Vint value corresponding to the picture signal frame, and sends an adjustment instruction to the IC that generates the Vint, so as to output the corresponding voltage value.

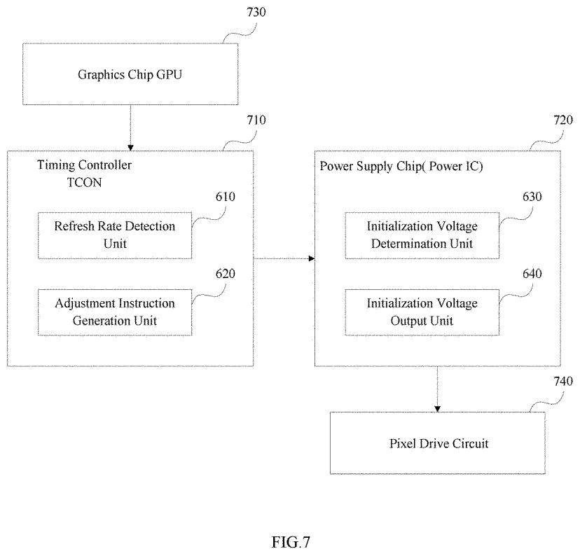

Further, referring to FIG. 7, the refresh rate detection unit 610 and the adjustment instruction generation unit 620 may be provided in the timing controller 710 of the display panel, and the initialization voltage determination unit 630 and the initialization voltage output unit 640 may be provided in the power supply chip 720 of the display panel. The timing controller 710 is electrically connected to the power supply chip 720. The timing controller 710 is also electrically connected to the graphics chip 730 of the display panel, and the refresh rate of the display panel is changed by changing the pixel clock frequency of the graphics chip 730. The power supply chip 720 is connected to the pixel drive circuit 740 of the display panel to drive the pixel drive circuit 740.

For the specific principles of each module unit of the driving system in this embodiment, reference may be made to the description of any driving method embodiment described above, which will not be repeated herein.

In summary, the driving method and driving system of the display panel of the present disclosure can reduce the brightness difference of the display panel when the refresh rate is switched by adjusting the initialization voltage, eliminate visual flicker of the screen, and improve the user experience.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

The above content is a further detailed description of the present disclosure in conjunction with specific preferred embodiments, and it cannot be considered that the specific implementation of the present disclosure is limited to these descriptions. For those of ordinary skill in the technical field to which the present disclosure belongs, a number of simple deductions or substitutions can be made without departing from the concept of the present disclosure, and these should be regarded as belonging to the protection scope of the present disclosure.

What is claimed is:

1. A driving method of a display panel, comprising:
detecting a refresh rate of each frame of the display panel;
in response to that the refresh rate of a current frame of the display panel changes relative to the refresh rate of a previous frame of the current frame, generating an adjustment instruction of an initialization voltage;
determining a target initialization voltage of the current frame based on the adjustment instruction of the initialization voltage; and
at a reset phase of the current frame, initializing a pixel drive circuit of the display panel with the target initialization voltage, so that a difference value between a working current of the pixel drive circuit in the current frame and a working current of the pixel drive circuit in the previous frame is less than a preset threshold.

2. The driving method according to claim 1, wherein said generating the adjustment instruction of the initialization voltage comprises:
in response to that the refresh rate of the current frame decreases relative to the refresh rate of the previous frame, generating an initialization voltage increase instruction.

3. The driving method according to claim 2, wherein in response to that the refresh rate of the current frame decreases relative to the refresh rate of the previous frame, the display panel is switched from a dynamic picture displayed in the previous frame to a static picture to be displayed in the current frame.

4. The driving method according to claim 1, wherein said determining the target initialization voltage of the current frame comprises:
according to the adjustment instruction of the initialization voltage, analyzing and obtaining a display gray scale and a refresh rate of the current frame; and
based on the display gray scale and the refresh rate of the current frame, obtaining a target initialization voltage corresponding to the display gray scale and the refresh rate of the current frame from a preset mapping relationship regarding a display gray scale, a refresh rate and a target initialization voltage.

5. The driving method according to claim 1, further comprising:
at a charging phase of the current frame, charging the pixel drive circuit; and
at a display phase of the current frame, driving a light-emitting element of the pixel drive circuit to emit light.

6. The driving method according to claim 5, wherein the pixel drive circuit of each pixel of the display panel comprises:
a first transistor coupled between an initialization voltage terminal and a first node, and at the reset phase, initializing, via the first transistor, the first node with the target initialization voltage transmitted from the initialization voltage terminal;
a storage capacitor coupled between the first node and an anode power supply terminal;
a second transistor coupled between a data line and the first node, and at the charging phase, charging, via the second transistor, the first node and the storage capacitor with a data voltage transmitted from the data line; and
a third transistor coupled between an anode of the light-emitting element and the anode power supply terminal, and a control terminal of the third transistor being coupled to the first node, and at the display phase, driving, via the third transistor, the light-emitting element to emit light with voltage stored in the storage capacitor.

7. The driving method according to claim 6, wherein the pixel drive circuit of each pixel further comprises a fourth transistor coupled between the initialization voltage terminal and the anode of the light-emitting element,
wherein the target initialization voltage also used to, at a second reset stage of the current frame, initialize the anode of the light-emitting element via the fourth transistor, and the second reset phase is located between the charging phase and the display phase.

8. The driving method according to claim 1, wherein the preset threshold is an amount of current change corresponding to a brightness difference that is not noticeable to human eyes under a gray scale.

9. A driving system of a display panel comprising:
a refresh rate detection unit configured to detect a refresh rate of each frame of the display panel;
an adjustment instruction generation unit configured to generate an adjustment instruction of an initialization voltage, in response to that the refresh rate of a current frame of the display panel changes relative to the refresh rate of a previous frame of the current frame;
an initialization voltage determination unit configured to determine a target initialization voltage of the current frame based on the adjustment instruction of the initialization voltage; and
an initialization voltage output unit configured to, at a reset phase of the current frame, initialize a pixel drive circuit of the display panel with the target initialization voltage, so that a difference value between a working current of the pixel drive circuit in the current frame and a working current of the pixel drive circuit in the previous frame is less than a preset threshold.

10. The driving system according to claim 9, wherein the refresh rate detection unit and the adjustment instruction generation unit are provided in a timing controller of the display panel, and the initialization voltage determination unit and the initialization voltage output unit are provided in a power supply chip of the display panel, and the timing controller is electrically connected to the power supply chip.

11. The driving system according to claim 10, wherein the timing controller is further electrically connected to a graphics chip of the display panel, and a change of the refresh rate of the display panel is realized by changing a pixel clock frequency of the graphics chip.

12. The driving system according to claim 9, wherein the adjustment instruction generation unit configured to in response to that the refresh rate of the current frame decreases relative to the refresh rate of the previous frame, generate an initialization voltage increase instruction.

13. The driving system according to claim 12, wherein in response to that the refresh rate of the current frame decreases relative to the refresh rate of the previous frame, the display panel is switched from a dynamic picture displayed in the previous frame to a static picture to be displayed in the current frame.

14. The driving system according to claim 9, wherein the initialization voltage determination unit configured to:
according to the adjustment instruction of the initialization voltage, analyze and obtain a display gray scale and a refresh rate of the current frame; and
based on the display gray scale and the refresh rate of the current frame, obtain a target initialization voltage corresponding to the display gray scale and the refresh rate of the current frame from a preset mapping relationship regarding a display gray scale, a refresh rate and a target initialization voltage.

15. The driving system according to claim 9, wherein the initialization voltage output unit is further configured to:
at a charging phase of the current frame, charge the pixel drive circuit; and
at a display phase of the current frame, drive a light-emitting element of the pixel drive circuit to emit light.

16. The driving system according to claim 9, wherein the pixel drive circuit of each pixel of the display panel comprises:
a first transistor coupled between an initialization voltage terminal and a first node, and at the reset phase, initializing, via the first transistor, the first node with the target initialization voltage transmitted from the initialization voltage terminal;
a storage capacitor coupled between the first node and an anode power supply terminal;
a second transistor coupled between a data line and the first node, and at the charging phase, charging, via the second transistor, the first node and the storage capacitor with a data voltage transmitted from the data line; and
a third transistor coupled between an anode of the light-emitting element and the anode power supply terminal, and a control terminal of the third transistor being coupled to the first node, and at the display phase, driving, via the third transistor, the light-emitting element to emit light with voltage stored in the storage capacitor.

17. The driving system according to claim 16, wherein the pixel drive circuit of each pixel further comprises a fourth transistor coupled between the initialization voltage terminal and the anode of the light-emitting element,
wherein the target initialization voltage also used to, at a second reset stage of the current frame, initialize the anode of the light-emitting element via the fourth transistor, and the second reset phase is located between the charging phase and the display phase.

18. The driving system according to claim 9, wherein the preset threshold is an amount of current change corresponding to a brightness difference that is not noticeable to human eyes under a gray scale.
